(19) United States
(12) Patent Application Publication
(10) Pub. No.: US 2012/0281420 A1
(43) Pub. Date: Nov. 8, 2012

(54) COMBINED OPTICAL ELEMENT AND LIGHTING DEVICE INCLUDING THE SAME

(75) Inventor: Nami Sawada, Hyogo (JP)

(73) Assignee: PANASONIC CORPORATION, Osaka (JP)

(21) Appl. No.: 13/502,179

(22) PCT Filed: Oct. 24, 2011
(86) PCT No.: PCT/JP2011/005924

§ 371 Date: Apr. 16, 2012

(30) Foreign Application Priority Data
Oct. 26, 2010 (JP) 2010-239259

(51) Int. Cl. F21V 5/04; G02B 3/06

(52) U.S. Cl. 362/311.06; 359/710

(57) ABSTRACT

A combined optical element of the present invention includes a first optical element for collecting light in one direction on an irradiated surface; and a second optical element for collecting light in another direction on the irradiated surface. The first optical element and the second optical element are superposed with light-incoming surfaces thereof as being a common surface, and a light-outgoing surface is formed only with a superposed part. This prevents light from irradiating unnecessary parts, which allows the irradiated surface of a photographic subject to be irradiated with a small amount of light emission.

### TECHNICAL FIELD

The present invention relates to a combined optical element that is bright in spite of its small size and is able to irradiate only a necessary range as an auxiliary light source for a photographing device such as a digital still camera (DSC), mobile phone, and video camera, and to a lighting device including the combined optical element.

### BACKGROUND ART

Conventionally, a photographing device such as a DSC, mobile phone, and video camera has a built-in flash lighting device for brightly irradiating a photographic subject to allow photographing at nighttime and in a dark location.

Hereinafter, a description is made of a camera-equipped mobile phone for example as a photographing device with a built-in flash lighting device. FIG. 7 is a front view for illustrating a configuration of a camera-equipped mobile phone.

As shown in FIG. 7, outer body 17 is equipped with various types of buttons 18, release button 19 used to photograph, liquid crystal display 20, electronic camera 21, and flash device 22. Buttons 18 are provided at the lower front side of outer body 17 with which numeric and other characters are entered. Display 20 is provided at the upper front side of outer body 17 on which communication information and images are displayed. Electronic camera 21 is placed at the upper side of display 20 with its lens exposed.

In recent years, photographing devices such as a camera-equipped mobile phone have been rapidly increasing their number of pixels, enabling high-resolution, clear image display. For this reason, a flash lighting device is demanded able to irradiate a photographic subject more brightly and uniformly.

As a flash lighting device satisfying the above demand, lighting device 27 as shown in FIG. 8 is applicable. FIG. 8 is a schematic diagram of a conventional lighting device.

As shown in FIG. 8, lighting device 27 includes LED light source 23 as a point source and optical lens 24 (refer to patent literature 1 for example). Optical lens 24 has light-incoming surface 25 facing LED light source 23 and light-outgoing surface 26 placed opposite to LED light source 23 (closer to a photographic subject). In this case, LED light source 23 itself of lighting device 27 is equipped with an optical system, and thus radiated light emitted from LED light source 23 forms a circular distribution pattern at a positive irradiation angle owing to light collection. Then, the radiated light from LED light source 23 can be collected in a required light distribution pattern by controlling the radiated light in the circular distribution pattern using optical lens 24.

However, LED light source 23 of lighting device 27 is a point LED light source, and thus radiated light emitted from optical lens 24 is irradiated conically even if controlled using optical lens 24. Consequently, lighting device 27 irradiates a photographic subject with light in a circular pattern.

Meanwhile, the screen size of a photo usually has an aspect ratio (i.e. the proportional relationship between the width of an image and its height) of 4:3. Accordingly, when lighting device 27 circularly irradiates a photographic subject, light at the four parts (i.e. bow-shaped parts 13) irradiated lying off from the square outer circumference of irradiated surface 16 of the photographic subject, in a bow-shape does not contribute to photographing. Consequently, light emitted from lighting device 27 cannot be used effectively for lighting irradiated surface 16 of the photographic subject.

### CITATION LIST

### Patent Literature

PTL 1 Japanese Utility Model No. 3,148,803

### SUMMARY OF THE INVENTION

To solve the above problem, a combined optical element of the present invention includes a first optical element for collecting light in one direction on an irradiated surface; and a second optical element for collecting light in another direction on the irradiated surface. The first optical element and the second optical element are superposed with light-incoming surfaces thereof as being a common surface, and a light-outgoing surface is formed only with a superposed part.

Herewith, light from the point source can be collected to within the irradiated surface, allowing the light to be used effectively, which helps implement a small-size, bright lighting device. Further, power consumption of a photographing device including the lighting device can be reduced to extend the battery life.

### BRIEF DESCRIPTION OF DRAWINGS

FIG. 1 is a perspective view of a lighting device according to an exemplary embodiment of the present invention.

FIG. 2A is a perspective view of a first optical element contributing to light distribution characteristics in the vertical direction of a combined optical element according to the same exemplary embodiment.

FIG. 2B is a perspective view of a second optical element contributing to light distribution characteristics in the horizontal direction of the combined optical element according to the same exemplary embodiment.

FIG. 2C is a perspective view of an optical element produced by combining the first optical element of FIG. 2A with the second optical element of FIG. 2B according to the same exemplary embodiment.

FIG. 3 is a sectional view of the lighting device according to the same exemplary embodiment.

FIG. 4 is an outline perspective view illustrating a state lighted by the lighting device according to the same exemplary embodiment.

FIG. 5 is a perspective view of another example of a combined optical element according to the same exemplary embodiment.

FIG. 6 is a perspective view of yet another example of a combined optical element and a lighting device including the element, according to the same exemplary embodiment.

FIG. 7 is a front view illustrating a configuration of a camera-equipped mobile phone.

FIG. 8 is a schematic diagram of a conventional lighting device.

### DESCRIPTION OF EMBODIMENTS

Hereinafter, a description is made of a combined optical element and a lighting device including the element, according to an exemplary embodiment of the present invention with reference to the related drawings. The present invention is not limited by the exemplary embodiment.

### Exemplary Embodiment

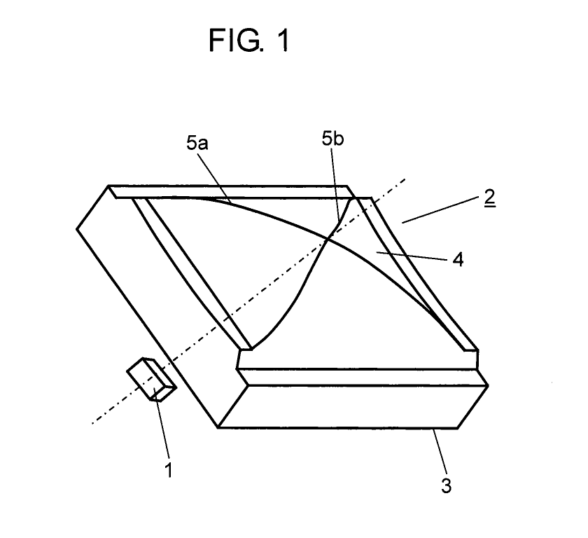

Hereinafter, a description is made of a combined optical element and a lighting device including the element, according to an exemplary embodiment of the present invention using FIGS. 1 through 6.

FIG. 1 is a perspective view showing a lighting device according to an exemplary embodiment of the present invention.

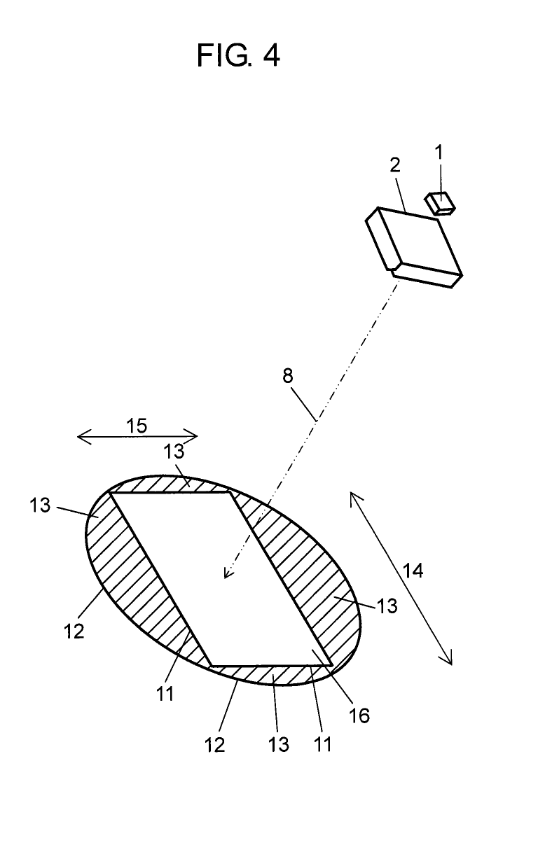

As shown in FIG. 1, a lighting device of the exemplary embodiment is composed of at least point source 1 made of an LED chip for example and combined optical element 2. Combined optical element 2 is composed of two sets of cylindrical lenses for example, where light-incoming surface 3 of combined optical element 2 and point source 1 are placed facing each other. Here, light-incoming surface 3, which light emitted from point source 1 of combined optical element 2 enters, is formed in a rectangle, flat plane. Meanwhile, light is emitted from light-outgoing surface 4, which is opposite (closer to a photographic subject) to light-incoming surface 3 of combined optical element 2, to light irradiated surface 16 (refer to FIG. 4) of photographic subject. This configures a lighting device of the embodiment.

The above combined optical element 2 can be formed of a transparent resin material such as PMMA (polymethyl methacrylate), PC (polycarbonate), EP (epoxy resin), and silicone resin, or of transparent glass.

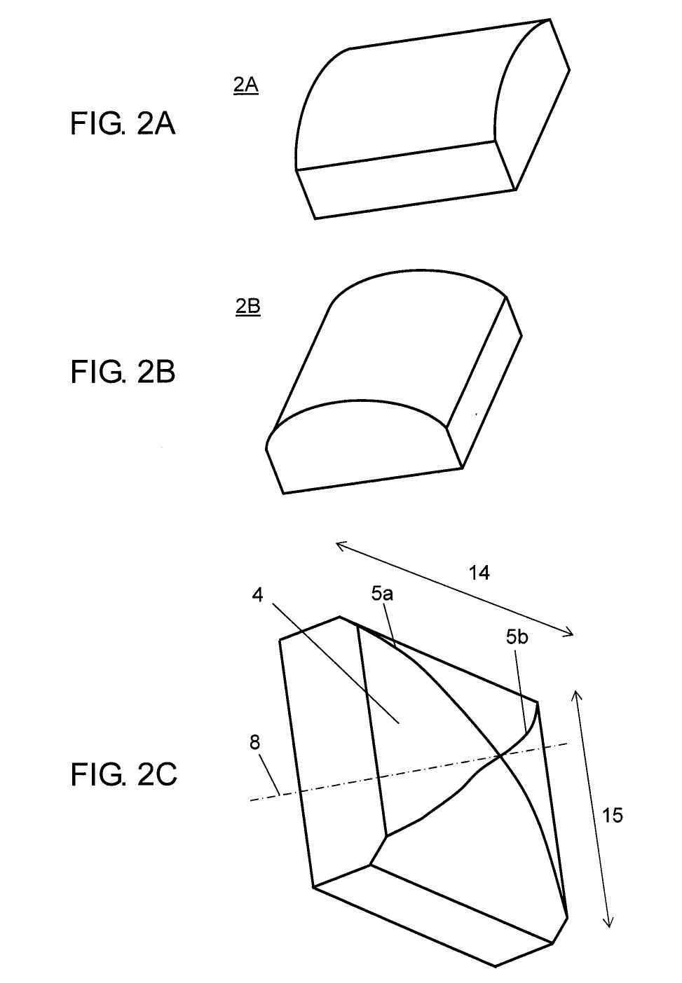

Hereinafter, a detailed description is made of a combined optical element composing a lighting device using FIGS. 2A through 2C referring to FIG. 4.

FIG. 2A is a perspective view of a first optical element contributing to light distribution characteristics in the vertical direction of a combined optical element according to the same exemplary embodiment. FIG. 2B is a perspective view of a second optical element contributing to light distribution characteristics in the horizontal direction of the combined optical element according to the same exemplary embodiment. FIG. 2C is a perspective view of an optical element produced by combining the first optical element of FIG. 2A with the second optical element of FIG. 2B according to the same exemplary embodiment. FIG. 4 is an outline perspective view illustrating a state lighted by a lighting device according to the same exemplary embodiment.

To sum up, as shown in FIG. 2C, combined optical element 2 is composed of first optical element 2A and second optical element 2B. Here, as shown in FIG. 2A, first optical element 2A is composed of a lens (e.g. cylindrical lens) with its cross section substantially or completely semicircular that effectively collects light in horizontal direction 14 of irradiated surface 16 shown in FIG. 4. Meanwhile, as shown in FIG. 2B, second optical element 2B is composed of a lens (e.g. cylindrical lens) with its cross section substantially or completely semicircular that effectively collects light in vertical direction 15 of irradiated surface 16 shown in FIG. 4.

Then, combined optical element 2 is produced by superposing two different types of optical elements (first optical element 2A and second optical element 2B) so that light-incoming surfaces 3 of the respective optical elements are level (flat plane) in the direction of optical axis 8. This forms combined optical element 2 shown in FIG. 2C having light-outgoing surface 4 with the superposed part of first optical element 2A and second optical element 2B as a lens. Here, the above combined optical element 2 may be referred to as a cylindrical combination lens.

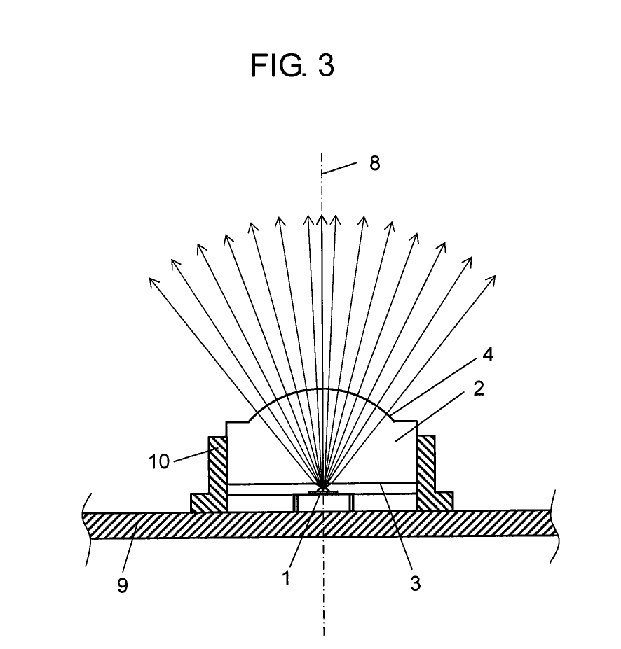

Hereinafter, a description is made of a lighting device including the above-described combined optical element using FIG. 3.

FIG. 3 is a sectional view showing a lighting device according to the exemplary embodiment of the present invention.

As shown in FIG. 3, when point source 1 (e.g. LED chip) placed close to combined optical element 2 emits light, the light on optical axis 8 enters light-incoming surface 3 of combined optical element 2 perpendicular thereto and travels out in a straight line from light-outgoing surface 4 of combined optical element 2.

Meanwhile, light that has spread from optical axis 8 in a circular pattern diagonally enters light-incoming surface 3 of combined optical element 2, and after being refracted in the direction of optical axis 8, the light leaves light-outgoing surface 4 having a shape of a convex lens, of combined optical element 2.

At this moment, two diagonal lines 5a and 5b (the diagonal lines of the superposed part of the semicircular surfaces for example, of first optical element 2A and second optical element 2B) are formed on light-outgoing surface 4 of combined optical element 2. Accordingly, light is emitted from each light-outgoing surface 4 of the four surfaces, divided by two diagonal lines 5a and 5b, in a shape closer to a rectangle (aspect ratio, here). This allows irradiated surface 16 to be irradiated in a shape of an aspect ratio. Consequently, light can be effectively collected to irradiate within a required range of irradiated surface 16 of a photographic subject.

Typically, as shown in FIG. 4, light emitted from point source 1 is irradiated spreading circularly. With combined optical element 2 of the present invention, light is irradiated on bow-shaped parts 13 (the hatched parts enclosed by arc 12 and each side 11 of the rectangle inscribed in the circle being collected on rectangular irradiated surface 16, thereby allowing the light to be used effectively.

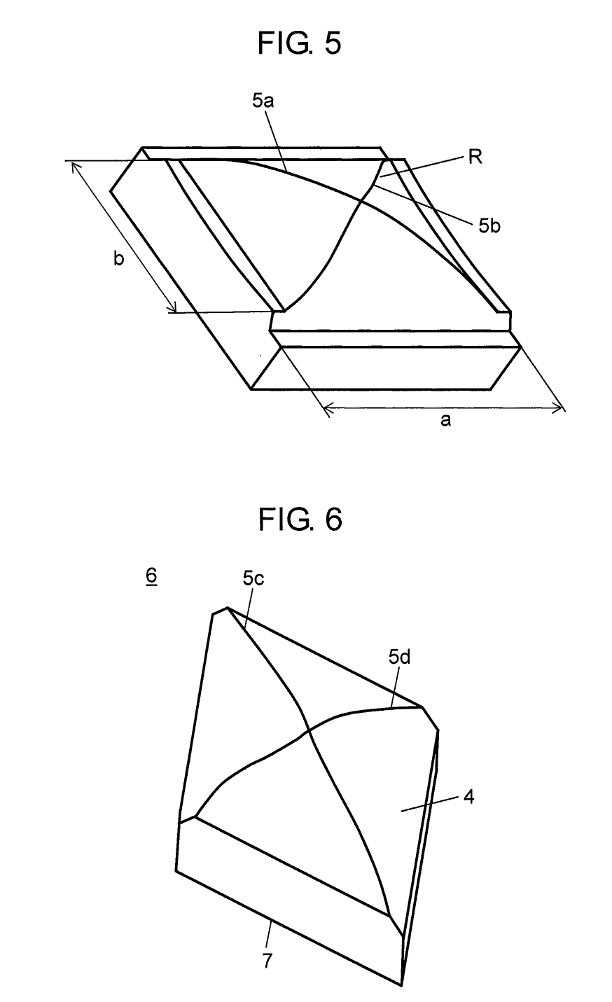

Hereinafter, a description is made of another example of a combined optical element of the exemplary embodiment using FIG. 5. FIG. 5 is a perspective view showing another example of a combined optical element according to the exemplary embodiment.

As shown in FIG. 5, curvature R satisfying a≦b and 0<R<a/2 is provided to the cross section of diagonal lines 5a and 5b of the surface where first optical element 2A and second optical element 2B overlap with each other. This further increases the optical convergence of combined optical element 2.

Here, a is the length of one side of rectangle combined optical element 2; b is the length of a side adjacent to a. R represents the curvature of light-outgoing surface 4 of combined optical element 2.

At this moment, the amount of light irradiated on the center of combined optical element 2 can be adjusted to a desired level by providing curvature R to diagonal lines 5a and 5b of the part where the surfaces of first optical element 2A and second optical element 2B of combined optical element 2 overlap with each other. Then, the optical convergence can be further increased by satisfying a≦b and 0<R<a/2.

Hereinafter, a further description is made of a configuration of a lighting device including the combined optical element structured as above using FIG. 3.

As shown in FIG. 3, the lighting device is composed of at least substrate 9, socket 10, combined optical element 2, and point source 1. Substrate 9 has an electric circuit wired thereto in a manner connectable to another circuit and has electronic components mounted thereon for forming such as a lighting circuit.

Then, combined optical element 2 is positioned and fixed by being inserted into socket 10 fixed onto substrate 9. Point source 1 faces light-incoming surface 3 of combined optical element 2 inside socket 10 on substrate 9, being mounted at optical axis 8 for example. In other words, point source 1 is placed on optical axis 8, which is an extended line connecting the center of combined optical element 2 with the center of irradiated surface 16 of a photographic subject.

At this moment, to make all the light emitted from point source 1 enter the inside of combined optical element 2, light-incoming surface 3 of combined optical element 2 is preferably placed close to point source 1.

Here, an LED chip, compact and low in power consumption, for example, is used for point source 1.

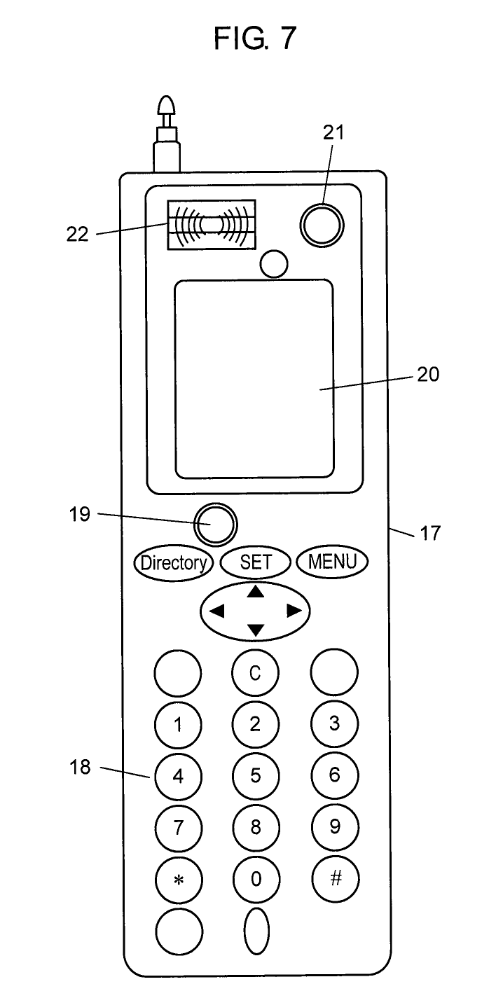

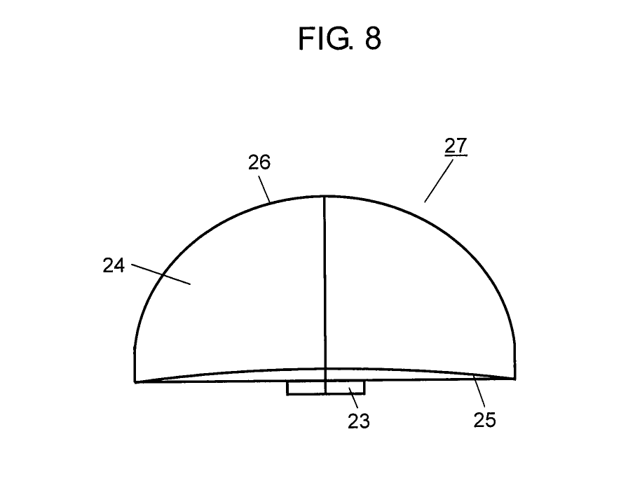

Hereinafter, a description is made of a lighting device of the exemplary embodiment, in a case where the lighting device is incorporated into a camera-equipped mobile phone for example, referring to FIG. 7.

More specifically, a lighting device of the exemplary embodiment is incorporated into outer body 17 of the camera-equipped mobile phone shown in FIG. 7 so that each side of the rectangle of combined optical element 2 of the lighting device is arranged parallel to each side of outer body 17 for example. When the photographing button of the mobile phone is turned on, the lighting device emits light according to the timing. At this moment, combined optical element 2 of the lighting device collects light on the irradiated surface within the range of photographing a photographic subject to effectively irradiate the photographic subject. This prevents light from irradiating unnecessary parts, which allows photographing with a small amount of light emission. This reduces power consumption of the mobile phone to extend the life of the battery with a limited capacity, thereby allowing long-time use.

Hereinafter, a description is made of yet another example of a combined optical element and a lighting device including the combined optical element, according to the exemplary embodiment of the present invention using FIG. 6.

FIG. 6 is a perspective view of yet another example of a combined optical element and a lighting device including the combined optical element, according to the exemplary embodiment of the present invention.

More specifically, as shown in FIG. 6, combined optical element 6 is different from above combined optical element 2 in that light-incoming surface 7 is diamond-shaped for example and irradiates the irradiated surface of a photographic subject in a diamond shape. The other components are the same as those of the lighting device of the above exemplary embodiment, and thus their description is omitted.

As shown in FIG. 6, combined optical element 6 of the exemplary embodiment is formed by superposing two different types of lens: a first optical element for effectively collecting light in horizontal direction 14 of an irradiated surface and a second optical element for effectively collecting light in vertical direction 15, as described below.

First, either one (e.g. the first one) of the first or second optical element is disposed with an incline of 45° for example to horizontal direction 14 viewed from the light axial direction. In this state, the inclined first optical element and the second one are superposed so that respective light-incoming surfaces 3 of the optical elements are level (flat plane). This forms combined optical element 6, diamond-shaped for example, shown in FIG. 6 having light-outgoing surface 4 with the superposed part of the first and second optical elements as a lens.

Hereinafter, a description is made of a lighting device including combined optical element 6 described above referring to FIG. 6.

As shown in FIG. 6, when point source 1 (e.g. LED chip) placed close to combined optical element 6 emits light, the light on optical axis 8 enters light-incoming surface 7 of combined optical element 6 perpendicular thereto and travels out in a straight line from light-outgoing surface 4 of combined optical element 6.

Meanwhile, light that has spread from optical axis 8 in a circular pattern diagonally enters light-incoming surface 7 of combined optical element 6, and after being refracted in the direction of optical axis 8, the light leaves light-outgoing surface 4 having a shape of a convex lens, of combined optical element 6.

At this moment, light-incoming surface 7 of combined optical element 6 is diamond-shaped since one optical element (e.g. the first one) is inclined 45°. Accordingly, light is emitted from each four light-outgoing surface 4, divided by two diagonal lines 5a and 5b, in a shape closer to a diamond.

As described above, combined optical element 6 of the exemplary embodiment allows the irradiated surface to be irradiated in a shape of a diamond.

Here, in another example of the exemplary embodiment as well, curvature R satisfying a≦b and 0<R<a/2 is preferably provided to diagonal lines 5a and 5b of the surface where the first and second optical elements overlap with each other. This further increases the optical convergence of combined optical element 6.

The present invention is not limited to the above-described exemplary embodiments, but various modifications may be added within a scope of the technical idea of the present invention.

For example, a lighting device of the present invention does not need to be incorporated into a mobile phone, but may be an external device, to which the present invention is applicable as well.

The irradiated surface of a photographic subject is not limited to a screen in an aspect ratio of 4:3, but may be a screen in screen aspect ratio, pixel aspect ratio, or high-definition TV.

The point source is not limited to an LED chip, but other elements can be used as well as long as they emit light for example.

In the exemplary embodiment, the description is made of the case where the light-incoming surface of the combined optical element is a flat plane as an example, but not limited to the case. The light-incoming surface may be a concave or convex surface with its center being the optical axis for example.

In the exemplary embodiment, the description is made of the case where the light-incoming surface of the combined optical element is rectangular or diamond-shaped as an example, but not limited to the case. Any irradiated surface such as a square and elliptical one may be formed by changing the dimensions of the first and second optical elements, the curvature of the light-outgoing surface, or the angle of superposition for example. This significantly expands the application range of a device with the lighting device incorporated thereinto.

A combined optical element of the present invention includes a first optical element for collecting light in one direction on an irradiated surface; and a second optical element for collecting light in another direction on the irradiated surface. The first optical element and the second optical element are superposed with light-incoming surfaces thereof as being a common surface, and a light-outgoing surface is formed only with a superposed part.

Herewith, light from the point source can be collected to within the irradiated surface, allowing the light to be used effectively, which helps implement a small-size, bright lighting device. Further, power consumption of a photographing device including the lighting device can be reduced to extend the battery life.

In a combined optical element of the present invention, the light-outgoing surface has curvature R satisfying a≦b and 0<R<a/2 in a diagonal cross section, where a is a length of a first side of the rectangle combined optical element, and b is a length of a second side adjacent to the first side. Herewith, the amount of light irradiated on the center of the combined optical element can be adjusted to a desired level.

In a lighting device of the present invention, the combined optical element is positioned close to the point source. Herewith, all the light emitted from point source 1 can be made enter the inside of the combined optical element.

### INDUSTRIAL APPLICABILITY

The present invention is widely applicable to equipment such as a DSC, mobile phone, and video camera as a lighting device for brightly irradiating a photographic subject.

### REFERENCE MARKS IN THE DRAWINGS

1 Point source
2, 6 Combined optical element
2A First optical element
2B Second optical element
3, 7, 25 Light-incoming surface
4, 26 Light-outgoing surface
5a, 5b, 5c, 5d Diagonal line
8 Optical axis
9 Substrate
10 Socket
11 Side
12 Arc
13 Bow-shaped part
14 Horizontal direction
15 Vertical direction
16 Irradiated surface
17 Outer body
18 Button
19 Release button
20 Display
21 Electronic camera
22 Flash device
23 LED light source
24 Optical lens
27 Lighting device

1. A combined optical element comprising:
a first optical element for collecting light in one direction on an irradiated surface; and
a second optical element for collecting light in another direction on the irradiated surface, wherein the first optical element and the second optical element having different optical convergences between the two respective directions are superposed with light-incoming surfaces thereof as being a common surface, and a light-outgoing surface is formed only with a superposed part.

2. The combined optical element of claim 1, wherein the first optical element and the second optical element are cylindrical lenses.

3. The combined optical element of claim 1, wherein curvature R satisfying a≦b and 0<R<a/2 is provided to a diagonal cross section of the light-outgoing surface of the combined optical element, a being a length of a first side of the rectangle combined optical element, b being a length of a second side adjacent to the first side.

4. A lighting device comprising the combined optical element of claim 1 positioned close to a point source.

5. The lighting devices of claim 4,
wherein a direction of light collection of the first optical element is orthogonal to a direction of light collection of the second optical element, and
wherein the irradiated surface is formed by aspect ratio.
